(19) United States
(12) Patent Application Publication
(10) Pub. No.: US 2022/0017390 A1
(43) Pub. Date: Jan. 20, 2022

(54) METHOD FOR THE PRECIPITATION OF ARSENIC AND HEAVY METALS FROM ACIDIC PROCESS WATER

(71) Applicant: EISENMANN ENVIRONMENTAL TECHNOLOGY GMBH, Böblingen (DE)

(72) Inventors: Jochen Schumacher, Tübingen (DE); Uwe Stein, Holzgerlingen (DE)

(21) Appl. No.: 17/286,377

(22) PCT Filed: Sep. 26, 2019
(86) PCT No.: PCT/EP2019/075993

§ 371 Date: Oct. 4, 2021

(51) Int. Cl. C02F 1/52

(52) U.S. Cl. CPC C02F 1/5236; C02F 2101/103

(57) ABSTRACT

The invention relates to a method for the precipitation of arsenic and heavy metals from acidic, in particular sulphuric acid, process water (12), containing both arsenic and heavy metals, comprising a precipitation method phase (II) with a precipitation stage (D) in which arsenic and at least one primary heavy metal are precipitated together, wherein a sulphide precipitating agent (20) is added to the process water (12) such that arsenic is precipitated as arsenic sulphide and the at least one primary heavy metal is precipitated as metal sulphide. The precipitation method phase (II) comprises a conditioning stage (C) which is carried out before the precipitation stage (D) and in which a conditioning agent (16) is added to the acidic process water (12), which has an effect on the character, in particular the filtering properties, at least of the precipitated arsenic sulphide.

The invention relates to a method for precipitating arsenic and heavy metal from acidic, especially sulfuric-acid, process water containing both arsenic and heavy metal, the method comprising a precipitation method section with a precipitation stage in which arsenic and at least one primary heavy metal are jointly precipitated by the addition to the process water of a sulfide precipitation reagent, causing precipitation of arsenic in the form of arsenic sulfide and of the at least one primary heavy metal in the form of metal sulfide.

Acidic process waters containing both arsenic and heavy metal are obtained as sulfuric-acid wastewaters in—for example—copper smelting or the fabrication of semiconductor components. There are many other industrial processes, though, in which acidic process waters bearing arsenic and heavy metals may be formed. Process waters of these kinds are also referred to as acidic washing water.

The term “primary heavy metal” is intended presently just to denote the heavy metal whose joint precipitation with arsenic is contemplated. The process water may additionally include other heavy metals, different from the primary heavy metal, with the primary heavy metal frequently being present at the greatest concentration in the process water in comparison to the other heavy metals. The invention is elucidated below using the above-stated example of process waters as are formed in downstream operations in the smelting of copper.

Flue gases containing sulfur are produced during the smelting of copper. They undergo a process—conventional per se—of flue gas treatment in the course of which the sulfur present is converted into sulfuric acid. The impurities present are ultimately collected in an acidic process water, which in the context of copper smelting is referred to as the washing solution or washing acid. A process water or washing acid of this kind may contain acid at concentrations between 1% and 35%. The process water therefore has a low and possibly even negative pH. As well as copper, process water of this kind contains further (heavy) metals, such as zinc, cadmium, molybdenum, lead, selenium and mercury, and also other impurities, including primarily arsenic.

Arsenic is an environmental toxin and the objective is therefore always to treat residual or waste materials such as such process waters that are produced, with the treatment setting the materials free as far as possible from arsenic and compounds thereof. It is known practice for this purpose, for example, to remove arsenic from washing acids in the form of the sulfide by precipitation.

DE 34 18 241 A1, for example, discloses a method for removing arsenic from waste sulfuric acids by using an aqueous solution of sodium sulfide, NaS₂, and sodium hydrogensulfide, NaHS, as sulfiding agent in a hydrogen sulfide atmosphere, where the amount of sodium sulfide in the agent is set superstoichiometrically to the arsenic content of the waste acid. Such precipitation reactions also cause precipitation in sulfide form of copper present in the process water, and of other heavy metals present. The precipitated sulfides, i.e., arsenic sulfide and copper sulfide and also the sulfides of other heavy metals present, are filtered out of the resulting filter mixture after the precipitation reaction, and the filter cake is subsequently disposed of. With known precipitation methods, arsenic sulfide is precipitated in the form of a kind of flakes which are distinguished by low density, small flake size, but a relatively large volume overall. These flakes exhibit a very low sedimentation tendency and in addition are mechanically unstable. In addition, therefore, during the filtering procedure, the arsenic sulfide flakes are easily triturated, and a kind of greasy film or sludge is formed which plugs the filter—in the form, for example, of a filter cloth—already after a short time, then rendering any further and/or effective filtering procedure no longer possible. Consequently, the filter must be changed after just small quantities of accumulated sulfides and a correspondingly short service life, which makes the filtering procedure not only labor-intensive and time-consuming but also expensive.

It is an object of the invention to provide a method of the aforementioned kind that forms a very stable and heavy flake, thus achieving effective sedimentation in conjunction with good filtration properties.

This object is achieved, in the context of a method of the aforementioned kind, in that

the precipitation method section comprises a conditioning stage which is implemented before the precipitation stage and in which the acidic process water is admixed with a conditioning agent which affects the nature, more particularly the filtration properties, at least of the precipitated arsenic sulfide.

In accordance with the invention it has been ascertained that it is possible to exert a favorable influence over the nature of the precipitated arsenic sulfide even prior to precipitation, by first adding a conditioning agent to the acidic process water, and only thereafter initiating sulfide precipitation for arsenic and the primary heavy metal. In accordance with the invention, then, it is possible to exert such a positive influence on the precipitation chemistry, even in the early stages of the precipitation reaction, that the precipitation products obtained exhibit significantly better sedimentation properties and filtration properties than precipitation products which are obtained without prior addition of a conditioning agent.

The conditioning agent is preferably hydrogen peroxide H₂O₂, or ozone, O₃. Contrary to the prevailing view, it has been recognized in accordance with the invention that a prior addition of hydrogen peroxide H₂O₂ or ozone O₃ not only possibly brings about an oxidation of As(III) present to As(V) but also, moreover, leads to precipitation products in the precipitation reaction, principally arsenic sulfide, which exhibit a more favorable nature in terms of the sedimentation capacity and the filtration properties. The arsenic sulfide precipitated by the method of the invention, and the precipitation products obtained, form a heavy, stable sludge which has good sedimentation and filtration properties and forms a filter cake which is indeed dense but does not cause plugging.

The filtration properties of the precipitation product are positively influenced even by the substoichiometric addition of conditioning agent relative to the arsenic content of the process water. Especially good results, however, are achieved if the conditioning agent is added stoichiometrically or even superstoichiometrically to the arsenic content of the process water.

Conditioning agent here is added preferably in a ratio of 0.5:1, preferably in a ratio of 1:1, more preferably in a ratio of 1.5:1, relative to the arsenic content of the process water. In practice, when using hydrogen peroxide H₂O₂ as conditioning agent, the filterability of the precipitation products obtained could be improved in proportion to the amount of H₂O₂ added.

In order to determine the required amount of conditioning agent it is an advantage if before the conditioning stage, in an analysis stage, the process water is analyzed at least for the arsenic content. In this way it is possible to implement a precipitation tailored to the actual arsenic content.

An exemplary embodiment of the method of the invention is elucidated below with figures, in which:

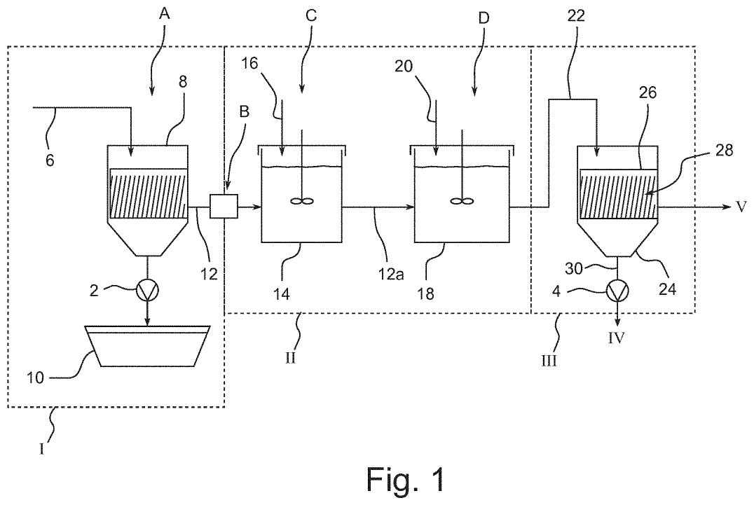

FIG. 1 shows a method scheme;

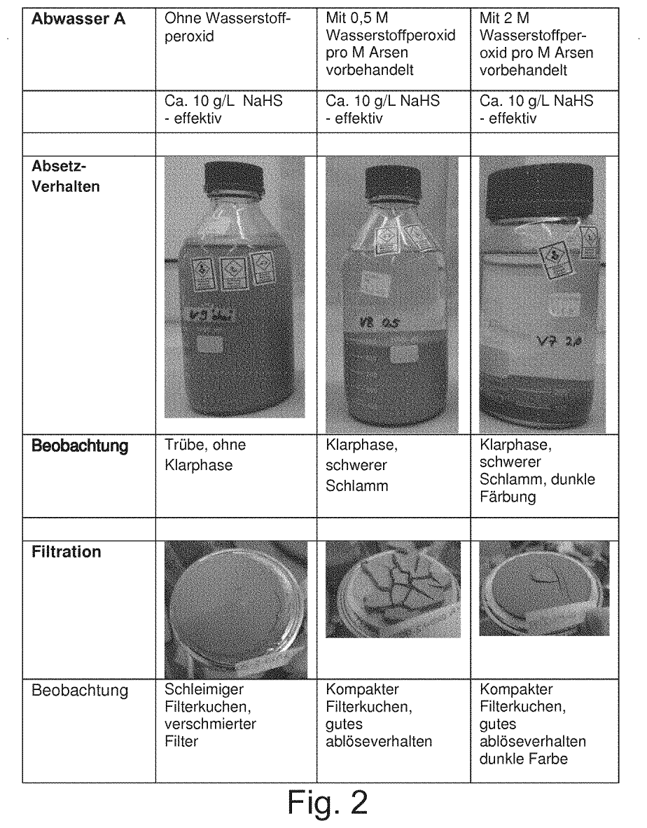

FIG. 2 shows photos of results of the method implemented on the laboratory scale.

In the scheme, two pumps are designated 2 and 4, and conveying lines are illustrated by arrows whose direction indicates the respective conveying direction. The conveying lines have not been labeled individually.

In a pretreatment method section denoted by I, there is a pretreatment in which a washing acid 6 obtained in the aforementioned flue gas treatment is first prepared for the separation of arsenic and copper. For example, undissolved particles of arsenic trioxide and dust particles carried in particular by the washing acid 6 can be precipitated using precipitation aids of the kind known per se, and separated off. For this purpose the washing acid 6, in a deposition or filter stage A, is passed via a feedline to a filter unit 8. The solids deposited are transferred into a collecting container 10, from where they are passed on to a disposal facility. The filtrate obtained now forms the process water 12 which is to be freed from arsenic and heavy metals, principally from copper. In an analysis stage B, the composition of the process water 12 is determined at least in relation to the arsenic content and also, in the case of the present exemplary embodiment, in respect of the copper content and/or the concentration of sulfuric acid. Process waters or washing acids of the kind contemplated here typically have a sulfuric acid content of between 1% and 35%, and contain between 3 g/L and 18 g/L of arsenic. The copper content is generally situated at orders of magnitude between 0.1 g/L and 12 g/L.

The method section I for pretreatment may comprise not only the filter stage A but also further treatment stages or treatment steps, but this is of no further interest here.

In the case of the present exemplary embodiment, copper defines the primary heavy metal. The process water 12 freed from dust is strongly acidic and has a pH=0. The process water 12 is then fed to a precipitation method section II, in which arsenic and copper are precipitated together and optionally with other heavy meals present. In this precipitation method section II, the process water 12 is first pumped into a conditioning reactor 14, where it is admixed, in a conditioning step C with stirring, with a conditioning agent 16 which affects the nature at least of the precipitated arsenic sulfide. In the present exemplary embodiment, the conditioning agent 16 added is hydrogen peroxide H₂O₂ or alternatively ozone O₃. As indicated above, the conditioning agent 16 is added substoichiometrically, stoichiometrically or superstoichiometrically relative to the arsenic content of the process water 12.

It is possible where appropriate to do without the method section I and a corresponding pretreatment. In that case the process water 12 corresponds to the washing acid 6; this acid is then passed directly into the treatment reactor 14.

After a corresponding residence time in the treatment reactor 14, the process water now conditioned, referred to by 12a, is transferred into a precipitation reactor 18 of a precipitation stage D. A sulfide precipitation reagent 20 is added therein to the conditioned process water 12a, with stirring. The sulfide precipitation reagent 20 employed in practice is inorganic sulfide, such as sodium hydrogen sulfide NaHS, for example. Also contemplated, however, are other sulfide precipitation reagents, such as disodium sulfide, Na₂S, for example. It is possible as well to use hydrogen sulfide, H₂S, which in turn may also be generated by means of hydrogen sulfide-producing bacteria, as is known per se. The sulfide precipitation reagent 20 is added to the conditioned process water 12a at a temperature of about 40° C. to 50° C.

In the precipitation reactor 18 there is a joint precipitation of arsenic sulfide and copper sulfide. Sulfides of the other heavy metals present may also undergo precipitation, but the liquid phase of the mixture 22 then present also contains dissolved cadmium and mercury in particular after the precipitation stage D.

The mixture 22 then present in the precipitation reactor 18 is now passed to a deposition section III, where it passes through one or more separation stages. Illustrated representatively in the figure is a separation stage E, in which the precipitation products present are separated off from the mixture 22 by means of a filter unit 24. In the case of the present exemplary embodiment, the mixture 22 is passed through a filter cloth 26, to give a filter cake 28 and a filtrate 30. In practice the mixture 22 is sedimented beforehand. As a result of the conditioning with the conditioning agent 16 prior to the precipitation procedure, the sedimentation time for the precipitation product can be reduced by up to 50% in comparison to the precipitation product obtained, which is obtained without the conditioning stage C. Conversely, the volume of the precipitation product obtained is reduced by up to more than 60%.

It is possible overall, as a result of the improved filtration properties of the precipitation product, to achieve a significant increase, possibly of more than two fold, in the service life of the filter unit 24 and especially of the filter cloth 26.

The filtrate 30 additionally contains at least the aforementioned cadmium and mercury, and is passed to a further treatment IV of the kind which is known per se, and so will not be addressed any further.

The filter cake 28 is collected and can be subsequently supplied—in a manner likewise known per se—to a disposal section V, and disposed of. As elucidated above, the filter cake 28 is generally incinerated.

In laboratory experiments, the method described above showed significant effects on the sedimentation and filtration properties of the precipitation products: in the case of a wastewater A having an arsenic concentration of 7.5 g/L, a copper concentration of 0.3 g/L and a sulfate concentration of 350 g/L, a total of 10 g/L of NaHS (effective) were added. With this it was possible, for the liquid fraction of the mixture 22 and/or for the filtrate 30, to reduce the arsenic concentration to below 50 mg/L and the copper concentration to below 1 mg/L. Even with a substochiometric addition of hydrogen peroxide H₂O₂, with a molar ratio of 0.5 to arsenic, it was possible to achieve a significantly larger and compact flake, a transparent clear phase, and a sludge volume lower by at least 20%, in comparison to precipitation without the prior addition of hydrogen peroxide H₂O₂.

In the case of a superstoichiometric addition of hydrogen peroxide H₂O₂, with a molar ratio of 2 to arsenic, it was possible to obtain an even more compact precipitated sludge, the volume of which is about 40% lower in comparison to precipitation without prior addition of hydrogen peroxide H₂O₂.

This is illustrated by the table in FIG. 2. As can be seen in column 2 therein, sulfide precipitation without prior addition of hydrogen peroxide H₂O₂ results in a cloudiness without a clear phase. There is poor sedimentation of the precipitation products or none at all; the filter cake which remains is slimy. Column 3 shows the result of the substoichiometric addition of hydrogen peroxide H₂O₂, whereby the precipitation products sediment well and there is a clear phase and a heavy sludge formed, which has good filtration properties, producing a compact filter cake that exhibits good detachment behavior from the filter. Column 4 of FIG. 2 demonstrates that with the superstoichiometric addition of hydrogen peroxide H₂O₂ there is, in particular, an even better sedimentation behavior.

In the case of a wastewater B with an arsenic concentration of 10 g/L, a copper concentration of 2 g/L and a sulfate concentration of 40 g/L, a total of 12 g/L of NaHS (active) were added. With this it was possible, for the liquid fraction of the mixture 22 and/or for the filtrate 30, to reduce the arsenic concentration to below 4 mg/L and the copper concentration to below 0.5 mg/L. Here again, hydrogen peroxide H₂O₂ was added substoichiometrically in a molar ratio of 0.5 to arsenic. Flake formation was likewise very positively influenced, and, in comparison to precipitation without prior addition of hydrogen peroxide H₂O₂, the settling rate was approximately halved and a sludge volume lower by at least 25% was attained.

1. A method for precipitating arsenic and heavy metal from acidic process water containing both arsenic and heavy metal, the method comprising:
a precipitation method section with a precipitation stage in which arsenic and at least one primary heavy metal are jointly precipitated by the addition to the process water of a sulfide precipitation reagent causing precipitation of arsenic in the form of arsenic sulfide and of the at least one primary heavy metal in the form of metal sulfide,
wherein the precipitation method section comprises a conditioning stage, which is implemented before the precipitation stage and in which the acidic process water is admixed with a conditioning agent, which affects the filtration properties, at least of the precipitated arsenic sulfide.

2. The method of claim 1, wherein the conditioning agent is hydrogen peroxide (H₂O₂) or ozone (O₃).

3. The method of claim 1, wherein the conditioning agent is added substoichiometrically, stoichiometrically or superstoichiometrically relative to the arsenic content of the process water.

4. The method of claim 3, wherein the conditioning agent is added in a ratio of 0.5:1, in a ratio of 1:1 or in a ratio of 1.5:1 relative to the arsenic content of the process water.

5. The method of claim 1, wherein, before the conditioning stage in an analysis stage, the process water is analyzed at least for the arsenic content.

6. The method of claim 1, wherein the acidic process water is sulfuric-acid process water.
